(19) United States
(12) Patent Application Publication
(10) Pub. No.: US 2024/0386591 A1
(43) Pub. Date: Nov. 21, 2024

(54) METHOD AND DEVICE FOR SIMULTANEOUS LOCALIZATION AND MAPPING INITIALIZATION

(71) Applicant: BEIJING ZITIAO NETWORK TECHNOLOGY CO., LTD., Beijing (CN)

(72) Inventors: Jiawei WEN, Beijing (CN); Hengkai GUO, Beijing (CN)

(21) Appl. No.: 18/570,471

(22) PCT Filed: May 23, 2022
(86) PCT No.: PCT/CN2022/094549

§ 371 Date: Dec. 14, 2023

(30) Foreign Application Priority Data
Jul. 7, 2021 (CN) 202110766203.1

(51) Int. Cl. G06T 7/579; G06V 10/44

(52) U.S. Cl. CPC G06T 7/579; G06V 10/44

(57) ABSTRACT

The application provides a method, a device, and a non-transitory computer-readable storage medium for simultaneous localization and mapping initialization. In the method, an operation of removing influence of rotation is performed to a predetermined number of continuous frame images that are obtained, and then initial key frames are screened, with a pre-built adaptive-sized sliding window, from the predetermined number of continuous frame images after the operation and the initial key frames are used for initialization.

### CROSS REFERENCE

The present application claims priority to Chinese Patent Application No. 202110766203.1, filed on Jul. 7, 2021 and entitled “Method, apparatus and storage medium for simultaneous localization and mapping initialization”, the entirety of which is incorporated herein by reference.

### FIELD

The present application relates to the field of image processing, in particular to a method, a device, and a non-transitory computer-readable storage medium for simultaneous localization and mapping initialization.

### BACKGROUND

With the development of computer vision technology, simultaneous localization and mapping technology is widely used in fields such as augmented reality, virtual reality, automatic driving and positioning and navigation of robots or drones and the like.

### SUMMARY

The present application provides a method, apparatus and storage medium for simultaneous localization and mapping initialization.

In a first aspect, embodiments of the present application provide a method for simultaneous localization and mapping initialization, comprising:
obtaining a predetermined number of continuous frame images and preprocessing the predetermined number of continuous frame images, the preprocessing comprising an operation of removing influence of rotation;
screening, with a pre-built adaptive-sized sliding window, initial key frames from the predetermined number of continuous frame images with the influence of rotation removed, the initial key frames comprising a plurality of key frames; and
performing, based on the plurality of key frames, simultaneous localization and mapping initialization.

In a possible implementation, the performing, based on the plurality of key frames, simultaneous localization and mapping initialization comprises:
determining relative poses of a first key frame and a last key frame in the plurality of key frames;
obtaining, based on the relative poses of the first key frame and the last key frame, three-dimensional space points of respective key frames in the plurality of key frames;
determining relative poses of respective key frames in the plurality of key frames based on the relative poses of the first key frame and the last key frame and the three-dimensional space points of respective key frames in the plurality of key frames; and
establishing an initial map based on the three-dimensional space points of respective key frames in the plurality of key frames and the relative poses of respective key frames in the plurality of key frames.

In a possible implementation, the determining relative poses of respective key frames in the plurality of key frames based on the relative poses of the first key frame and the last key frame and the three-dimensional space points of respective key frames in the plurality of key frames comprises:
determining positions of the three-dimensional space points of respective key frames in the plurality of key frames projected into the first key frame and the last key frame;
determining a first reprojection error based on the positions obtained by the projection; and
determining the relative poses of respective key frames in the plurality of key frames based on the first reprojection error and the three-dimensional space points of respective key frames in the plurality of key frames.

In a possible implementation, the first reprojection error is a reprojection error after removing the influence of rotation.

In a possible implementation, before the establishing an initial map based on the three-dimensional space points of respective key frames in the plurality of key frames and the relative poses of respective key frames in the plurality of key frames, further comprising:
determining a second reprojection error based on the three-dimensional space points of respective key frames in the plurality of key frames;
performing a global optimization based on the second reprojection error to obtain the three-dimensional space points of respective key frames in the plurality of key frames and the relative poses of respective key frames in the plurality of key frames after the optimization; and
wherein the establishing an initial map based on the three-dimensional space points of respective key frames in the plurality of key frames and the relative poses of respective key frames in the plurality of key frames comprises:
establishing the initial map based on the three-dimensional space points of respective key frames in the plurality of key frames and the relative poses of respective key frames in the plurality of key frames after the optimization.

In a possible implementation, the performing a global optimization based on the second reprojection error to obtain the three-dimensional space points of respective key frames in the plurality of key frames and the relative poses of respective key frames in the plurality of key frames after the optimization comprises:
deciding whether the second reprojection error reaches a predetermined error threshold; and
in response to a determination that the second reprojection error does not reach the predetermined error threshold, adjusting a size of the sliding window, determining the sliding window after adjustment as a new sliding window; reperforming the act of screening, with the new sliding window, initial key frames from the predetermined number of continuous frame images with the influence of rotation removed so that the second reprojection error reaches the predetermined error threshold, and obtaining the three-dimensional space points of respective key frames in the plurality of key frames and the relative poses of respective key frames in the plurality of key frames after the optimization.

In a possible implementation, the screening, with a pre-built adaptive-sized sliding window, initial key frames from the predetermined number of continuous frame images with the influence of rotation removed comprises:
screening the initial key frames in the sliding window with a pixel distance difference with the influence of rotation removed.

In a possible implementation, the determining relative poses of a first key frame and a last key frame in the plurality of key frames comprises:
extracting two-dimensional key points of the first key frame and the last key frame to obtain a two-dimensional key point of the first key frame and a two-dimensional key point of the last key frame; and
determining the relative poses of the first key frame and the last key frame with the two-dimensional key point of the first key frame and the two-dimensional key point of the last key frame.

In a possible implementation, the determining the relative poses of the first key frame and the last key frame with the two-dimensional key point of the first key frame and the two-dimensional key point of the last key frame comprises:
determining an essential matrix corresponding to the first key frame and the last key frame with the two-dimensional key point of the first key frame and the two-dimensional key point of the last key frame;
obtaining, based on the essential matrix, a rotation matrix R and a translation matrix T; and
determining, based on the rotation matrix R and the translation matrix T, the relative poses of the first key frame and the last key frame.

In a possible implementation, the obtaining, based on the relative poses of the first key frame and the last key frame, three-dimensional space points of respective key frames in the plurality of key frames comprises:
obtaining three-dimensional space points of the first key frame and the last key frame based on the relative poses of the first key frame and the last key frame; and
determining three-dimensional space points of respective key frames remaining in the plurality of key frames except the first key frame and the last key frame based on the three-dimensional space points of the first key frame and the last key frame and a feature matching relationship between frames in the plurality of key frames.

In a possible implementation, the obtaining three-dimensional space points of the first key frame and the last key frame based on the relative poses of the first key frame and the last key frame comprises:
performing, based on the relative poses of the first key frame and the last key frame, a triangulation calculation to obtain the three-dimensional space points of the first key frame and the last key frame.

In a second aspect, embodiments of the present application provide an apparatus for simultaneous localization and mapping initialization, comprising:
an image preprocessing module configured to obtain a predetermined number of continuous frame images and preprocess the predetermined number of continuous frame images, the preprocessing comprising an operation of removing influence of rotation;
a key frame screening module configured to screen, with a pre-built adaptive-sized sliding window, initial key frames from the predetermined number of continuous frame images with the influence of rotation removed, the initial key frames comprising a plurality of key frames; and
a simultaneous localization and mapping initialization module configured to perform, based on the plurality of key frames, simultaneous localization and mapping initialization.

In a possible implementation, the simultaneous localization and mapping initialization module is specifically configured to:
determine relative poses of a first key frame and a last key frame in the plurality of key frames;
obtain, based on the relative poses of the first key frame and the last key frame, three-dimensional space points of respective key frames in the plurality of key frames;
determine relative poses of respective key frames in the plurality of key frames based on the relative poses of the first key frame and the last key frame and the three-dimensional space points of respective key frames in the plurality of key frames; and
establish an initial map based on the three-dimensional space points of respective key frames in the plurality of key frames and the relative poses of respective key frames in the plurality of key frames.

In a possible implementation, the simultaneous localization and mapping initialization module is specifically configured to:
determine positions of the three-dimensional space points of respective key frames in the plurality of key frames projected into the first key frame and the last key frame;
determine a first reprojection error based on the positions obtained by the projection; and
determine the relative poses of respective key frames in the plurality of key frames based on the first reprojection error and the three-dimensional space points of respective key frames in the plurality of key frames.

In a possible implementation, the first reprojection error is a reprojection error after removing the influence of rotation.

In a possible implementation, the simultaneous localization and mapping initialization module is further configured to:
determine a second reprojection error based on the three-dimensional space points of respective key frames in the plurality of key frames;
perform a global optimization based on the second reprojection error to obtain the three-dimensional space points of respective key frames in the plurality of key frames and the relative poses of respective key frames in the plurality of key frames after the optimization; and
establish the initial map based on the three-dimensional space points of respective key frames in the plurality of key frames and the relative poses of respective key frames in the plurality of key frames after the optimization.

In a possible implementation, the simultaneous localization and mapping initialization module is specifically configured to:
decide whether the second reprojection error reaches a predetermined error threshold; and
the key frame screening module is further configured to in response to a determination that the second reprojection error does not reach the predetermined error threshold, adjust a size of the sliding window, determine the sliding window after adjustment as a new sliding window, reperform the act of screening, with the new sliding window, initial key frames from the predetermined number of continuous frame images with the influence of rotation removed so that the second reprojection error reaches the predetermined error threshold, and obtain the three-dimensional space points of respective key frames in the plurality of key frames and the relative poses of respective key frames in the plurality of key frames after the optimization.

In a possible implementation, the key frame screening module is configured to screen the initial key frames in the sliding window with a pixel distance difference with the influence of rotation removed.

In a possible implementation, the simultaneous localization and mapping initialization module is specifically configured to:
extract two-dimensional key points of the first key frame and the last key frame to obtain a two-dimensional key point of the first key frame and a two-dimensional key point of the last key frame; and
determine the relative poses of the first key frame and the last key frame with the two-dimensional key point of the first key frame and the two-dimensional key point of the last key frame.

In a possible implementation, the simultaneous localization and mapping initialization module is specifically configured to:
determine an essential matrix corresponding to the first key frame and the last key frame with the two-dimensional key point of the first key frame and the two-dimensional key point of the last key frame;
obtain, based on the essential matrix, a rotation matrix R and a translation matrix T; and
determine, based on the rotation matrix R and the translation matrix T, the relative poses of the first key frame and the last key frame.

In a possible implementation, the simultaneous localization and mapping initialization module is specifically configured to:
obtain three-dimensional space points of the first key frame and the last key frame based on the relative poses of the first key frame and the last key frame; and
determine three-dimensional space points of respective key frames remaining in the plurality of key frames except the first key frame and the last key frame based on the three-dimensional space points of the first key frame and the last key frame and a feature matching relationship between frames in the plurality of key frames.

In a possible implementation, the simultaneous localization and mapping initialization module is specifically configured to:
perform, based on the relative poses of the first key frame and the last key frame, a triangulation calculation to obtain the three-dimensional space points of the first key frame and the last key frame.

In a third aspect, embodiments of the present application provide a device for simultaneous localization and mapping initialization, comprising:
a processor;
a memory; and
a computer program;
wherein the computer program is stored in the memory and configured to be executed by the processor, and the computer program comprises an instruction for executing the method of the first aspect.

In a fourth aspect, embodiments of the present application provide a computer-readable storage medium, wherein the computer-readable storage medium stores a computer program that causes a server to execute the method of the first aspect.

In a fifth aspect, embodiments of the present application provide a computer program product, comprising a computer instruction that is executed by a processor to implement the method of the first aspect.

In a sixth aspect, embodiments of the present application provide a computer program, wherein the computer program causes a server to execute the method of the first aspect.

### BRIEF DESCRIPTION OF THE DRAWINGS

In order to more clearly explain the embodiments of the present application or the technical solutions in the prior art, in the following, the drawings that need to be used in the description of the embodiments or the prior art will be introduced briefly. Obviously, the drawings in the following description are only some embodiments of the present application. For those of ordinary skill in this field, other drawings can be obtained according to these drawings without any creative labor.

FIG. 1 is a schematic diagram of architecture of a system for simultaneous localization and mapping initialization provided by an embodiment of the present application;

FIG. 2 is a schematic flowchart of a method for simultaneous localization and mapping initialization provided by an embodiment of the present application;

FIG. 3 is a schematic flowchart of another method for simultaneous localization and mapping initialization provided by an embodiment of the present application;

FIG. 4 is a schematic diagram of a reprojection error provided by an embodiment of the present application;

FIG. 5 is a schematic flowchart of yet another method for simultaneous localization and mapping initialization provided by an embodiment of the present application;

FIG. 6 is a schematic diagram of simultaneous localization and mapping initialization;

FIG. 7 is a structural schematic diagram of an apparatus for simultaneous localization and mapping initialization provided by an embodiment of the present application; and

FIG. 8 is a schematic diagram of basic hardware architecture of a device for simultaneous localization and mapping initialization provided by the present application.

### DETAILED DESCRIPTION

The technical solutions in the embodiments of the present application will be clearly and completely described below with reference to the drawings in the embodiments of the present application. Obviously, the described embodiments are only part of the embodiments of the present application, but not all of them. Based on the embodiments in the present application, all other embodiments obtained by those of ordinary skill in this field without creative labor belong to the scope of protection of the present application.

Terms such as “first”, “second”, “third” and “fourth” etc. (if any) in the specification and claims and the above drawings of the present application, are used to distinguish similar objects, and are not necessarily used to describe a specific order or sequence. It should be understood that the data used in this way can be interchanged under appropriate circumstances, so that the embodiments of the present application described herein can be implemented in a sequence other than those illustrated or described herein. In addition, the terms “include” and “have” and any variations thereof are intended to cover non-exclusive inclusion. For example, a process, method, system, product or device that includes a series of steps or units is not necessarily limited to those steps or units that are clearly listed, but may include other steps or units that are not clearly listed or inherent to the process, method, product or device.

The key problems in simultaneous localization and mapping include a sensor estimating its own state accurately based on environmental information. The key step in a simultaneous localization and mapping system is to initialize the simultaneous localization and mapping system. For visual simultaneous localization and mapping, the initialization work is to establish the initial pose of the camera with the environmental information and provide preliminary spatial information for the subsequent positioning system.

However, most of the existing simultaneous localization and mapping initialization initialize with a certain number of continuous frame images, and the initialization time is longer, and because the pixel distance difference between the continuous frame images may be small, the initialization accuracy is low (simultaneous localization and mapping initialization requires sufficient parallax between the frame images). Therefore, how to reduce the time of simultaneous localization and mapping initialization, and improve initialization accuracy has become an urgent problem to be solved.

In the related art, by taking the simultaneous localization and mapping system in a mobile terminal device as an example, the simultaneous localization and mapping system is used to obtain the pose of the mobile terminal device itself, the environment where the mobile terminal device is located, and the position of the mobile device in the environment. When a user uses the mobile terminal device, the simultaneous localization and mapping system is initialized firstly, and then the real-time construction and other processing of a scene map are performed based on it. The time of initializing the simultaneous localization and mapping system affects the waiting time of the user using the mobile terminal device, and the accuracy of the initialization of the simultaneous localization and mapping system affects the effect of augmented reality, virtual reality, automatic driving and other applications based on the simultaneous localization and mapping system.

Most of the existing simultaneous localization and mapping initialization initialize with a certain number of continuous frame images, and the initialization time is longer, and because the pixel distance difference between the continuous frame images may be small, the initialization accuracy is low. Therefore, how to reduce the time of simultaneous localization and mapping initialization, and improve the initialization accuracy has become an urgent problem to be solved.

In order to solve the above problems, embodiments of the present application propose a method for simultaneous localization and mapping initialization, which performs simultaneous localization and mapping initialization through initial key frames screened from a certain number of continuous frame images, and reduces the time of simultaneous localization and mapping initialization. Moreover, embodiments of the present application screen initial key frames in a window after removing the influence of rotation to ensure that there is enough parallax between the frames in the window on the premise of sufficient common view to perform simultaneous localization and mapping initialization, reduce the impact of rotation on simultaneous localization and mapping initialization at the same time, improve the accuracy of simultaneous localization and mapping initialization, and realize a more accurate camera spatial position solution, so as to provide map point information more accurately.

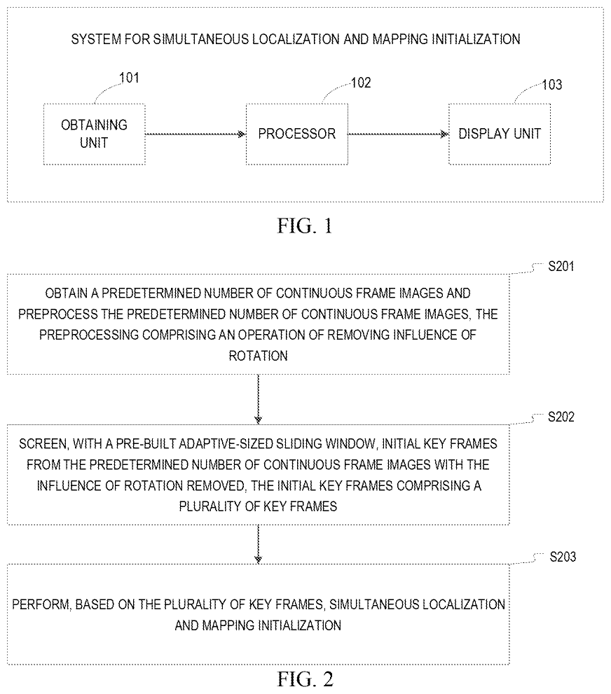

Alternatively, a method for simultaneous localization and mapping initialization provided in the embodiments of the present application can be applied to the application scenario as shown in FIG. 1. FIG. 1 is only an example of a possible application scenario of the method for simultaneous localization and mapping initialization provided by an embodiment of the present application. The application scenario of the method for simultaneous localization and mapping initialization provided by embodiments of the present application is not limited to the application scenario shown in FIG. 1.

FIG. 1 is a schematic diagram of architecture of a system for simultaneous localization and mapping initialization. In FIG. 1, a user processing a video on a mobile terminal device is taken as an example, where the mobile terminal device can be a mobile phone or a tablet, etc. The above architecture can include an obtaining unit 101, a processor 102 and a display unit 103.

It can be understood that the schematic architecture of the embodiments of the present application does not constitute a specific limitation on the architecture of simultaneous localization and mapping initialization. In other feasible embodiments of the present application, the above architecture may include more or less components than those shown, or some components may be combined, or some components may be split, or different components may be arranged, which may be determined according to the actual application scenario, and is not limited here. The components shown in FIG. 1 can be implemented in hardware, software, or a combination of software and hardware.

Taking a mobile phone as an example of the above mobile terminal device, the obtaining unit 101 can be a camera on the mobile phone. The user can shoot a video through the camera on the mobile phone, and then send the captured video to the processor 102 for processing. Here, in addition to the camera, the obtaining unit 101 can also be an input/output interface or a communication interface. The user can receive video and other information sent by other users through the interface, and send the received video to the processor 102 for processing. The processor 102 can store the video in a predetermined sequence after obtaining the video. The predetermined sequence stores the video based on the order of each frame in the video. For example, the order of each frame in the video is frame 1, then frame 2 . . . , then frame n−1, and finally frame n. The predetermined sequence stores the above video based on the above order, that is frame 1, frame 2, . . . , frame n−1 and frame n.

In the specific implementation process, the processor 102 obtains a certain number of continuous frame images from the above sequence, such as frame 1, frame 2 . . . Frame 25, and then screen, with a pre-built adaptive-sized sliding window, initial key frames from the above predetermined number of continuous frame images. For example, the size of the sliding window is the size of 5 image frames, the processor 102 screen the initial key frames from the above predetermined number of continuous frame images with the sliding window so that simultaneous localization and mapping initialization is performed based on the screened initial key frames, and the time of simultaneous localization and mapping initialization is reduced. In addition, the processor 102 preprocesses the predetermined number of continuous frame images that are obtained. the preprocessing including an operation of removing influence of rotation and screen the initial key frames in the sliding window with a pixel distance difference with the influence of rotation removed. For example, frame 6, frame 7, frame 10, frame 12 and frame 13 are screened as the initial key frames. There is enough parallax between the frames in the window on the premise of sufficient common view for simultaneous localization and mapping initialization that is guaranteed, the influence of rotation on simultaneous localization and mapping initialization is reduced at the same time, and the accuracy of simultaneous localization and mapping initialization is improved.

The display unit 103 can be configured to display the above initial key frames, results of simultaneous localization and mapping initialization, etc. The display unit 103 can also be a touch display screen which is configured to receive user instructions while displaying the above content, so as to realize interaction with the user.

It should be understood that the system architecture and business scenarios described in the embodiments of the present application are provided only for the purpose of more clearly illustrating the technical solution of the embodiments herein, and do not constitute a limitation on the technical solution provided by the embodiments of the present application. Those of ordinary skill in the art know that with the evolution of network architecture and the emergence of new business scenarios, the technical solution provided in the embodiments of this application are equally applicable to similar technical problems.

Several embodiments are taken as examples below to describe the technical solution of this application. The same or similar concepts or processes may not be repeated in some embodiments.

FIG. 2 is a schematic flowchart of a method for simultaneous localization and mapping initialization provided by an embodiment of the present application. The execution body of the present embodiment can be the processor 102 in FIG. 1, and the specific execution body can be determined based on the actual application scenario, and the embodiment of the present application do not intend to make special restrictions. As shown in FIG. 2, the method for simultaneous localization and mapping initialization provided by an embodiment of the present application may include the following steps:

S201: obtain a predetermined number of continuous frame images and preprocess the predetermined number of continuous frame images, the preprocessing comprising an operation of removing influence of rotation.

The predetermined number of continuous frame images can be determined based on the actual situation, such as frame 1, frame 2, . . . , frame 25 in the video shown in FIG. 1.

Here, the reason for the above preprocessing is that rotation influences the pixel distance difference of the frame, but simultaneous localization and mapping initialization cannot be performed only with the rotation. Therefore, in order to solve this problem, the embodiment of the present application performs the above preprocessing, and screen the initial key frames in the window with a pixel distance difference with the influence of rotation removed to ensure that there is enough parallax between the frames in the window on the premise of sufficient common vision for simultaneous localization and mapping initialization.

In addition, the processor can obtain information of rotation from a inertia measuring unit, so as to determine the pixel distance difference of the frames with the influence of rotation based on the obtained information, performing a process of removing the influence of rotation on the above predetermined number of continuous frame images, and screen the initial key frames in the sliding window with the pixel distance difference with the influence of rotation removed.

S202: screen, with a pre-built adaptive-sized sliding window, initial key frames from the predetermined number of continuous frame images with the influence of rotation removed. the initial key frames comprising a plurality of key frames.

Here, the processor can pre-build the adaptive-sized sliding window; that is, the size of the sliding window can be adjusted, and the specific size can be determined based on the actual situation, such as the size of 5 image frames to the size of 10 image frames. The processor screen, with the pre-built adaptive-sized sliding window, the initial key frames from the predetermined number of continuous frame images with the influence of rotation removed. For example, the length of the current sliding window is 5 frames, and the processor screen the initial key frames in the sliding window with a pixel distance difference with the influence of rotation removed. For example, frame 1, frame 2, . . . , frame 25 in the video shown in FIG. 1 are screened, and frame 6, frame 7, frame 10, frame 12 and frame 13 are selected as the initial key frames. If simultaneous localization and mapping initialization cannot be performed correctly through the size of 5 image frames, the size of the sliding window will be increased to the size of 6 image frames, and the initial key frames with the influence of rotation removed are continued to be screened, initialization computing is performed, and the window is slid until the simultaneous localization and mapping initialization is completed.

In the embodiments of the present application, the processor performs simultaneous localization and mapping initialization based on the initial key frames screened from a certain number of continuous frames, which reduces the time of simultaneous localization and mapping initialization. Moreover, the processor screens the initial key frames in the sliding window with a pixel distance difference with the influence of rotation removed, which guarantees that there is enough parallax between the frames in the window on the premise of sufficient common view for simultaneous localization and mapping initialization, reduces the influence of rotation on simultaneous localization and mapping initialization at the same time, and improves the accuracy of simultaneous localization and mapping initialization.

S203: perform, based on the plurality of key frames, simultaneous localization and mapping initialization.

As an example, the processor can determine relative poses of a first key frame and a last key frame in the initial key frames firstly, and then obtain three-dimensional space points of respective key frames in the plurality of key frames based on the relative poses of the first key frame and the last key frame, and determine relative poses of respective key frames in the plurality of key frames based on the relative poses of the first key frame and the last key frame and the three-dimensional space points of respective key frames in the plurality of key frames, and establish an initial map based on the three-dimensional space points of respective key frames in the plurality of key frames and the relative poses of respective key frames in the plurality of key frames.

Here, due to the known rotation, as well as the non-objective scale and other reasons, the processor can perform simultaneous localization and mapping initialization with only two frames after screening the initial key frames. In the embodiments of the present application, in order to ensure sufficient parallax between the frames in the window on the premise of sufficient common vision, the processor can use the first key frame and the last key frame of the initial key frames to perform simultaneous localization and mapping initialization.

As an example, the processor can extract two-dimensional key points of the first key frame and last key frame to obtain a two-dimensional key point of the first key frame and a two-dimensional key point of the last key frame, so as to determine the relative poses of the first key frame and the last key frame with the two-dimensional key point of the first key frame and the two-dimensional key point of the last key frame.

Further, the processor can determine an essential matrix corresponding to the first key frame and the last key frame with the two-dimensional key point of the first key frame and the two-dimensional key point of the last key frame, and then obtain, based on the essential matrix, a rotation matrix R and a translation matrix T so as to determine, based on the rotation matrix R and the translation matrix T, the relative poses of the first key frame and the last key frame.

The processor can use a random consistency sampling method to determine the essential matrix corresponding to the first key frame and last key frame, and then solve the rotation matrix R and translation matrix T from the essential matrix by singular value decomposition. Here, the rotation matrix R and translation matrix T are the pose parameters of the camera, and the rotation matrix R is known. Therefore, the processor determines the relative pose of the first key frame and last key frame based on the rotation matrix R and the translation matrix T.

Here, the processor can obtain the three-dimensional space points of respective key frames in the plurality of key frames based on the triangulation calculation.

As an example, the processor can perform triangulation calculation based on the relative poses of the first key frame and last key frame to obtain the three-dimensional space points of the first key frame and last key frame. Then, based on the three-dimensional space points of the first key frame and the last key frame, as well as a feature matching relationship between frames in the initial key frames, the processor can determine the three-dimensional space points of remaining respective frames in the plurality of key frames except the first key frame and last key frame, and thus the three-dimensional space points of respective key frames in the plurality of key frames are obtained.

Here, as an example, the processor performing the triangulation calculation example can include the following steps:

For example, regarding the homogeneous coordinates [x,y,z,1]^{T} of the three-dimensional space points, the projection of three-dimensional space points on the image is

$$λ [ \begin{matrix}u \\ v \\ 1\end{matrix} ] = {\underbrace{k 〈 R \vert T 〉}}_{P} [ \begin{matrix}x \\ y \\ z \\ 1\end{matrix} ]$$

Where k is the camera intrinsic matrix, R is the rotation matrix, T is the translation matrix. Here, k [symbol] R|T

[symbol]

is denoted by parameter

$$P , [ \begin{matrix}u \\ v \\ 1\end{matrix} ]$$

is denoted by

$$u , [ \begin{matrix}x \\ y \\ z \\ 1\end{matrix} ]$$

is denoted by X, thereby obtaining:

λu=PX

By multiplying both sides by u at the same time,

u\hat{ }PX=0

is obtained

Expand to obtain:

$$[ \begin{matrix}0 & - 1 & v \\ 1 & 0 & - u \\ - v & u & 0\end{matrix} ] [ \begin{matrix}{p}_{1} \\ {p}_{2} \\ {p}_{3}\end{matrix} ] x = 0$$

Further obtained:

$$\{ \begin{matrix}( {vp}_{3} - {p}_{2} ) x = 0 \\ ( {p}_{1} - {up}_{3} ) x = 0 \\ ( {up}_{2} - {vp}_{1} ) x = 0\end{matrix}$$

Two of the above three equations are linearly independent because equation (1) ×(−u)-equation (2)×v=equation (3), where Pi is the row of the matrix P. One frame can form two equations, so two frames can form four equations:

$${\underbrace{[ \begin{matrix}{v}_{1} {P}_{3}^{1} - {P}_{2}^{1} \\ {P}_{1}^{1} - {u}_{1} {P}_{3}^{1} \\ {v}_{2} {P}_{3}^{2} - {P}_{2}^{2} \\ {P}_{1}^{2} - {u}_{2} {P}_{3}^{2}\end{matrix} ]}}_{H} X = 0$$

Here, singular value decomposition may be used, and the homogeneous coordinates X are the singular vector of the least singular values of H.

In addition, after obtaining the relative pose of the first key frame and last key frame and the three-dimensional space points of respective key frames in the plurality of key frames, the processor can determine the relative poses of respective key frames in the plurality of key frames based on this information, and then establish a more accurate initial map to complete simultaneous localization and mapping initialization.

In the embodiments of the present application, the processor preprocesses the predetermined number of continuous frame images that are obtained, the preprocessing including the operation of removing the influence of rotation, and then screen, with a pre-built adaptive-sized sliding window; initial key frames from the predetermined number of continuous frame images with the influence of rotation removed so as to perform simultaneous localization and mapping initialization based on the plurality of key frames. Compared with the existing simultaneous localization and mapping initialization, embodiments of the present application perform simultaneous localization and mapping initialization based on the initial key frames screened from a certain number of continuous frame images, which reduces the time of simultaneous localization and mapping initialization. Moreover, embodiments of the present application screen the initial key frames in the window after removing the influence of rotation, which guarantees that there is enough parallax between the frames in the window on the premise of sufficient common view for simultaneous localization and mapping initialization. reduces the influence of rotation on simultaneous localization and mapping initialization at the same time, improves the accuracy of simultaneous localization and mapping initialization, and realize a more accurate camera spatial position solution, so as to provide map point information more accurately.

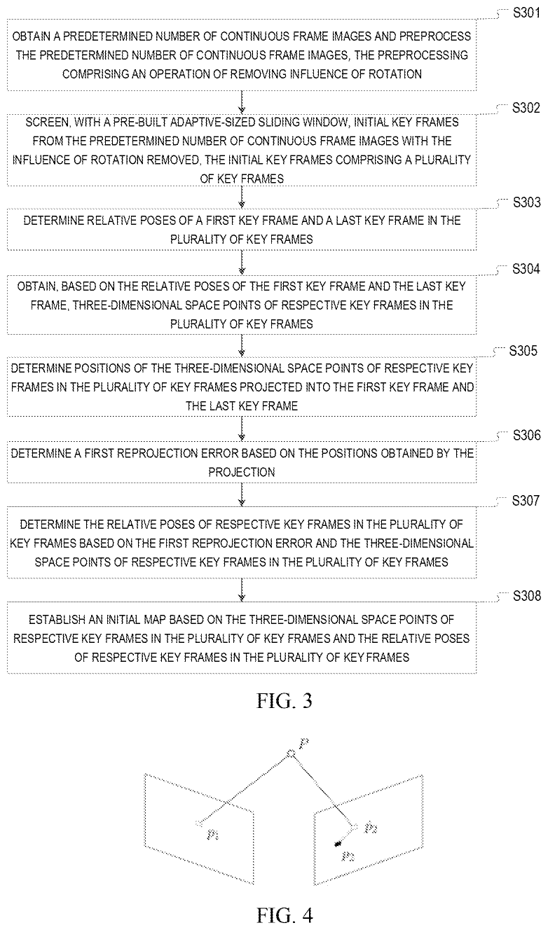

In addition, when determining the relative poses of respective key frames in the plurality of key frames based on the relative poses of the first key frame and last key frame and the three-dimensional space points of respective key frames in the plurality of key frames, the embodiment of the present application also considers determining positions of the three-dimensional space points of respective key frames in the plurality of key frames projected into the first key frame and the last key frame, and based on the positions, a local optimization problem is constructed, so as to determine the relative poses of respective key frames in the initial key frames based on this optimization problem, and improve the accuracy of simultaneous localization and mapping initialization. The optimization problem can take a reprojection error as the loss function. FIG. 3 is a schematic flowchart of another method for simultaneous localization and mapping initialization provided by an embodiment of the present application. As shown in FIG. 3, the method includes:

S301: obtain a predetermined number of continuous frame images and preprocess the predetermined number of continuous frame images, the preprocessing comprising an operation of removing influence of rotation.

S302: screen, with a pre-built adaptive-sized sliding window, initial key frames from the predetermined number of continuous frame images with the influence of rotation removed, the initial key frames comprising a plurality of key frames.

Steps S301-S302 are implemented in the same way as the above steps S201-S202 and are not elaborated herein.

S303: determine relative poses of a first key frame and a last key frame in the plurality of key frames.

S304: obtain, based on the relative poses of the first key frame and the last key frame, three-dimensional space points of respective key frames in the plurality of key frames.

S305: determine positions of the three-dimensional space points of respective key frames in the plurality of key frames projected into the first key frame and the last key frame.

S306: determine a first reprojection error based on the positions obtained by the projection.

S307: determine the relative poses of respective key frames in the plurality of key frames based on the first reprojection error and the three-dimensional space points of respective key frames in the plurality of key frames.

The perspective N-point method is used to estimate the pose of the camera when part of the coordinates of three-dimensional space points under world coordinate system and their two-dimensional camera coordinate system are known. In the embodiments of the present application, the processor can use the perspective N-point method to determine positions of the three-dimensional space points of respective key frames in the plurality of key frames projected into the first key frame and the last key frame, and then construct an optimization problem based on the positions, and determine the relative poses of respective key frames in the initial key frames based on the optimization problem.

Here, the optimization problem takes a reprojection error as the loss function. The reprojection error is an error obtained by comparing the pixel coordinates (the observed projection position) with the position obtained by projecting the three-dimensional space point based on the current estimated pose (for example, positions of the three-dimensional space points of respective key frames in the plurality of key frames projected into the first key frame and the last key frame).

As an example, when the processor determines the relative poses of respective key frames in the initial key frames based on the reprojection error, the processor constructs a local optimization problem. The optimization problem takes the reprojection error as a loss function, and when the loss function value reaches a predetermined error threshold, the relative poses of respective key frames in the initial key frame are obtained. For example, the processor determines whether the reprojection error reaches the predetermined error threshold (the predetermined error threshold can be determined based on the actual situation). If the reprojection error does not reach the predetermined error threshold, the processor can adjust the size of the sliding window and determine the sliding window after adjustment as a new sliding window, reperform the act of screening, with the new sliding window, initial key frames from the predetermined number of continuous frame images with the influence of rotation removed so that the reprojection error reaches the predetermined error threshold, and obtain the relative poses of respective key frames in the plurality of key frames based on the three-dimensional space points of respective key frames in the plurality of key frames, and the accuracy of simultaneous localization and mapping initialization is improved.

The reprojection error is a reprojection error after removing the influence of rotation.

The calculation of the reprojection error is shown in FIG. 4. The observed values p₁ and p₂ are the projection of the same space point p, the projection \hat{p}₂ of p has a certain distance to the observed value p₂, i.e., the reprojection error.

Considering n three-dimensional space points P and their projections p, R and T are calculated, which may be expressed as ξ. Suppose a given space point pᵢ=[Xᵢ,Yᵢ,Zᵢ]^{T}, the pixel coordinates of its projection are uᵢ=[uᵢ,vᵢ]^{T}.

The relationship between pixel position and space point position is as follows:

$${s}_{i} [ \begin{matrix}{u}_{i} \\ {v}_{i} \\ 1\end{matrix} ] = k {\underbrace{exp ( ξ \hat{} )}}_{R , T} [ \begin{matrix}{X}_{i} \\ {Y}_{i} \\ {Z}_{i} \\ 1\end{matrix} ]$$

Where, sᵢ is the distance (depth), k is the camera intrinsic matrix, R is the rotation matrix, and T is the translation matrix.

Correspondingly, the matrix form is: sᵢuᵢ=k exp (ξ\hat{ }) pᵢ.

There is an error in this equation due to the unknown camera pose and the noise of the observation point. Here, a sum of errors may be calculated to construct the least squares problem, and then the optimal camera pose is sought to minimize it:

$${ξ}^{*} = arg min \frac{1}{2} {\sum }_{i = 1}^{n} {‖ {u}_{i} - \frac{1}{{s}_{i}} k exp ( ξ \hat{} ) {p}_{i} ‖}_{2}^{2}$$

It can be solved by Gauss-Newton method/Levenberg-Marquardt method.

S308: establish an initial map based on the three-dimensional space points of respective key frames in the plurality of key frames and the relative poses of respective key frames in the plurality of key frames.

In the embodiments of the present application, when the processor determines the relative pose of respective key frames in the plurality of key frames based on the relative pose of the first key frame and last key frame and the three-dimensional space points of respective key frames in the plurality of key frames, embodiments of the present application also consider determining positions of the three-dimensional space points of respective key frames in the plurality of key frames projected into the first key frame and the last key frame, and construct a local optimization problem based on the positions, thereby determining the relative poses of respective key frames in the plurality of key frames based on the optimization problem, and improving the accuracy of simultaneous localization and mapping initialization. In addition, embodiments of the present application perform simultaneous localization and mapping initialization based on the initial key frames screened from a certain number of continuous frame images, which reduces the time of simultaneous localization and mapping initialization. Moreover, embodiments of the present application screen the initial key frames in the window after removing the influence of rotation, which guarantees that there is enough parallax between the frames in the window on the premise of sufficient common view for simultaneous localization and mapping initialization, reduces the influence of rotation on simultaneous localization and mapping initialization at the same time, improves the accuracy of simultaneous localization and mapping initialization correspondingly, and realize a more accurate camera spatial position solution.

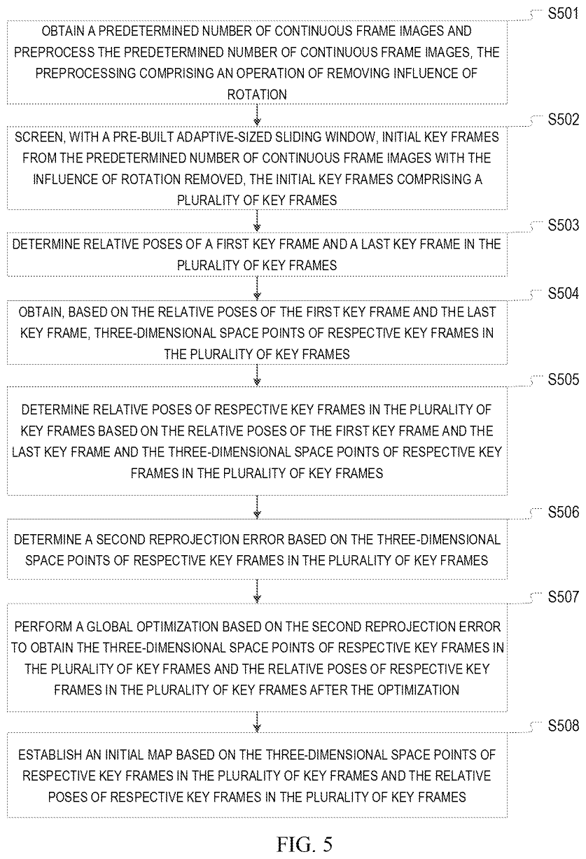

In addition, before the processor establishes an initial map based on the three-dimensional space points of respective key frames in the plurality of key frames and the relative poses of respective key frames in the plurality of key frames, the embodiments of the present application also consider determining a second reprojection error based on the three-dimensional space points of respective key frames in the plurality of key frames, and then construct a global optimization problem. Based on the optimization problem, the three-dimensional space points of respective key frames in the plurality of key frames and the relative poses of respective key frames in the plurality of key frames are obtained, and the initial map is established to accurately provide map point information. FIG. 5 is a schematic flowchart of yet another method for simultaneous localization and mapping initialization provided by an embodiment of the present application. As shown in FIG. 5, the method includes:

S501: obtain a predetermined number of continuous frame images and preprocess the predetermined number of continuous frame images, the preprocessing comprising an operation of removing influence of rotation.

S502: screen, with a pre-built adaptive-sized sliding window, initial key frames from the predetermined number of continuous frame images with the influence of rotation removed, the initial key frames comprising a plurality of key frames.

The steps S501-S502 are implemented in the same way as the above steps S201-S202, which will not be elaborated herein.

S503: determine relative poses of a first key frame and a last key frame in the plurality of key frames.

S504: obtain, based on the relative poses of the first key frame and the last key frame, three-dimensional space points of respective key frames in the plurality of key frames.

S505: determine relative poses of respective key frames in the plurality of key frames based on the relative poses of the first key frame and the last key frame and the three-dimensional space points of respective key frames in the plurality of key frames.

S506: determine a second reprojection error based on the three-dimensional space points of respective key frames in the plurality of key frames.

Here, the processor can determine positions of the three-dimensional space points of respective key frames in the plurality of key frames projected into a plurality of key frames, and then, the above reprojection error is determined based on the positions obtained by the projection.

S507: perform a global optimization based on the second reprojection error to obtain the three-dimensional space points of respective key frames in the plurality of key frames and the relative poses of respective key frames in the plurality of key frames after the optimization.

As an example, after determining the above reprojection error, the processor can construct a global optimization problem, which determines the above reprojection error as a loss function, and then three-dimensional space points of respective key frames in the plurality of key frames and the relative poses of respective key frames in the plurality of key frames after the optimization are obtained based on the optimization problem. For example, the processor determines whether the reprojection error reaches the predetermined error threshold. If the reprojection error does not reach the predetermined error threshold, the processor can adjust the size of the sliding window and determine the sliding window after adjustment as a new sliding window; reperform the act of screening, with the new sliding window, initial key frames from the predetermined number of continuous frame images with the influence of rotation removed so that the reprojection error reaches the predetermined error threshold, and obtains the three-dimensional space points of respective key frames in the plurality of key frames and the relative poses of respective key frames in the plurality of key frames after the optimization. Therefore, the initial map is established based on the information after the optimization to provide map point information accurately.

S508: establish an initial map based on the three-dimensional space points of respective key frames in the plurality of key frames and the relative poses of respective key frames in the plurality of key frames.

In the embodiment of this application, before the processor establishes an initial map based on the three-dimensional space points of respective key frames in the plurality of key frames and the relative poses of respective key frames in the plurality of key frames, the embodiments of the present application also consider determining a second reprojection error based on the three-dimensional space points of respective key frames in the plurality of key frames, and then construct a global optimization problem. Based on the optimization problem, the three-dimensional space points of respective key frames in the plurality of key frames and the relative poses of respective key frames in the plurality of key frames are obtained, and the initial map is established to accurately provide map point information. Moreover, embodiments of the present application screen the initial key frames in the window after removing the influence of rotation, which guarantees that there is enough parallax between the frames in the window on the premise of sufficient common view for simultaneous localization and mapping initialization, reduces the influence of rotation on simultaneous localization and mapping initialization at the same time, improves the accuracy of simultaneous localization and mapping initialization, and realize a more accurate camera spatial position solution.

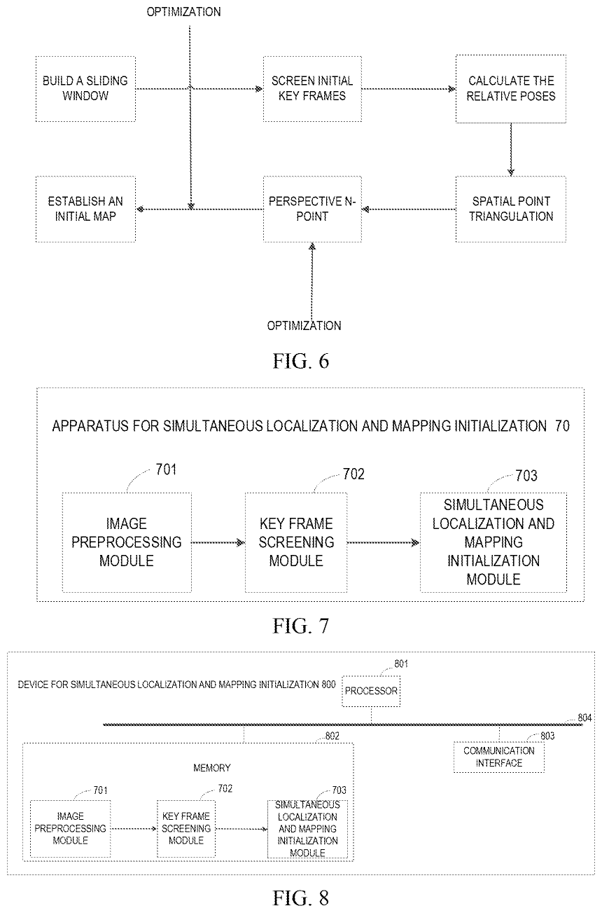

Here, as shown in FIG. 6, take frame 1, frame 2, . . . , frame 25 in the video shown in FIG. 1 as an example of the predetermined number of continuous frame images. The processor first builds a sliding window that is adjustable in size, for example the current size of the sliding window is the size of 5 frames. Then, the processor preprocesses a predetermined number of continuous frame images, the preprocessing including the operation of removing the influence of rotation, and screen initial key frames in the window with the pixel distance difference with the influence of rotation removed, that is, frame 1, frame 2, . . . , frame 25 in the video shown in FIG. 1 are screened, and frame 6, frame 7, frame 10, frame 12, frame 13 are obtained by screening. Then, the processor can use the random consistency sampling method to calculate the relative poses of the first key frame and the last key frame in the initial key frames. Based on the relative poses of the first key frame and the last key frame, and the feature matching relationship between frames, the spatial point triangulation is performed to obtain the three-dimensional space points of respective key frames in the initial key frames. After obtaining the relative poses of respective key frames in the initial key frames, the processor can use the perspective N-point method to determine positions of the three-dimensional space points of respective key frames in the plurality of key frames projected into the first key frame and the last key frame, and then construct a local optimization problem based on the positions, and determine the relative poses of respective key frames in the initial key frames based on the optimization problem. Finally, the processor can determine the reprojection error based on the three-dimensional space points of respective key frames in the initial key frames, and then construct a global optimization problem, so as to establish an initial map based on the three-dimensional space points of respective key frames in the initial key frames and the relative poses of respective key frames in the initial key frames after the optimization.

Compared with the existing simultaneous localization and mapping initialization, the processor performs simultaneous localization and mapping initialization based on the initial key frames screened from a certain number of continuous frame images, which reduces the time of simultaneous localization and mapping initialization. In addition, the processor constructs a local optimization problem to determine the relative poses of respective key frames in the initial key frames to improve the accuracy of simultaneous localization and mapping initialization. In addition, the processor constructs a global optimization problem to obtain the three-dimensional space points of respective key frames in the initial key frames and the relative poses of respective key frames in the initial key frames after the optimalization to establish the initial map so as to accurately provide the map point information. In addition, the processor screens the initial key frames in the sliding window with a pixel distance difference with the influence of rotation removed, which guarantees that there is enough parallax between the frames in the window on the premise of sufficient common view for simultaneous localization and mapping initialization, reduces the influence of rotation on simultaneous localization and mapping initialization at the same time, improves the accuracy of simultaneous localization and mapping initialization and realize a more accurate camera spatial position solution.

Corresponding to the method for simultaneous localization and mapping initialization in the above embodiments, FIG. 7 is a structural schematic diagram of an apparatus for simultaneous localization and mapping initialization provided by an embodiment of the present application. For the sake of illustration, only the parts relevant to the embodiments of the present application are shown. FIG. 7 is a structural schematic diagram of an apparatus for simultaneous localization and mapping initialization provided by an embodiment of the present application. The apparatus for simultaneous localization and mapping initialization 70 comprises: an image preprocessing module 701, a key frame screening module 702, and a simultaneous localization and mapping initialization module 703. The apparatus for simultaneous localization and mapping initialization herein may be the above processor itself, or a chip or integrated circuit that performs the function of the processor. It should be noted that the image preprocessing module, the key frame screening module, and the simultaneous localization and mapping initialization module are divided in terms of logical functionality, two of which may be physically integrated or independent.

The image preprocessing module 701 is configured to obtain a predetermined number of continuous frame images and preprocess the predetermined number of continuous frame images, the preprocessing comprising an operation of removing influence of rotation. The key frame screening module 702 is configured to screen with a pre-built adaptive-sized sliding window, initial key frames from the predetermined number of continuous frame images with the influence of rotation removed, the initial key frames comprising a plurality of key frames.

The simultaneous localization and mapping initialization module 703 is configured to perform, based on the plurality of key frames, simultaneous localization and mapping initialization.

In a possible implementation, the simultaneous localization and mapping initialization module 703 is specifically configured to:
determine relative poses of a first key frame and a last key frame in the plurality of key frames;
obtain, based on the relative poses of the first key frame and the last key frame, three-dimensional space points of respective key frames in the plurality of key frames;
determine relative poses of respective key frames in the plurality of key frames based on the relative poses of the first key frame and the last key frame and the three-dimensional space points of respective key frames in the plurality of key frames;
establish an initial map based on the three-dimensional space points of respective key frames in the plurality of key frames and the relative poses of respective key frames in the plurality of key frames.

In a possible implementation, the simultaneous localization and mapping initialization module 703 is specifically configured to:
determine positions of the three-dimensional space points of respective key frames in the plurality of key frames projected into the first key frame and the last key frame;
determine a first reprojection error based on the positions obtained by the projection; and
determine the relative poses of respective key frames in the plurality of key frames based on the first reprojection error and the three-dimensional space points of respective key frames in the plurality of key frames.

In a possible implementation, the first reprojection error is a reprojection error after removing the influence of rotation.

In a possible implementation, the simultaneous localization and mapping initialization module 703 is further configured to:
determine a second reprojection error based on the three-dimensional space points of respective key frames in the plurality of key frames;
perform a global optimization based on the second reprojection error to obtain the three-dimensional space points of respective key frames in the plurality of key frames and the relative poses of respective key frames in the plurality of key frames after the optimization; and
establish the initial map based on the three-dimensional space points of respective key frames in the plurality of key frames and the relative poses of respective key frames in the plurality of key frames after the optimization.

In a possible implementation, the simultaneous localization and mapping initialization module 703 is specifically configured to:
decide whether the second reprojection error reaches a predetermined error threshold; and
the key frame screening module is further configured to in response to a determination that the second reprojection error does not reach the predetermined error threshold, adjust a size of the sliding window, determine the sliding window after adjustment as a new sliding window, reperform the act of screening, with the new sliding window, initial key frames from the predetermined number of continuous frame images with the influence of rotation removed so that the second reprojection error reaches the predetermined error threshold, and obtain the three-dimensional space points of respective key frames in the plurality of key frames and the relative poses of respective key frames in the plurality of key frames after the optimization.

In a possible implementation, the key frame screening module 703 is specifically configured to screen the initial key frames in the sliding window with a pixel distance difference with the influence of rotation removed.

In a possible implementation, the simultaneous localization and mapping initialization module 703 is specifically configured to:
extract two-dimensional key points of the first key frame and the last key frame to obtain a two-dimensional key point of the first key frame and a two-dimensional key point of the last key frame; and
determine the relative poses of the first key frame and the last key frame with the two-dimensional key point of the first key frame and the two-dimensional key point of the last key frame.

In a possible implementation, the simultaneous localization and mapping initialization module 703 is specifically configured to:
determine an essential matrix corresponding to the first key frame and the last key frame with the two-dimensional key point of the first key frame and the two-dimensional key point of the last key frame; obtain, based on the essential matrix, a rotation matrix R and a translation matrix T; and determine, based on the rotation matrix R and the translation matrix T, the relative poses of the first key frame and the last key frame.

In a possible implementation, the simultaneous localization and mapping initialization module 703 is specifically configured to:
obtain three-dimensional space points of the first key frame and the last key frame based on the relative poses of the first key frame and the last key frame; and
determine three-dimensional space points of respective key frames remaining in the plurality of key frames except the first key frame and the last key frame based on the three-dimensional space points of the first key frame and the last key frame and a feature matching relationship between frames in the plurality of key frames.

In one possible implementation, the simultaneous localization and mapping initialization module 703 is specifically configured to:
perform, based on the relative poses of the first key frame and the last key frame, a triangulation calculation to obtain the three-dimensional space points of the first key frame and the last key frame.

The apparatus provided in the embodiments of the present application can be used to implement the technical solution of the method embodiments, with similar implementation principle and technical effect, which will not be repeated herein.

Alternatively, FIG. 8 is a schematic diagram of basic hardware architecture of a device for simultaneous localization and mapping initialization provided by the present application.

Referring to FIG. 8, a device for simultaneous localization and mapping initialization includes at least one processor 801 and a communication interface 803. Alternatively, a memory 802 and a bus 804 may be included.

The number of processors 801 in the device for simultaneous localization and mapping initialization 800 can be one or more, and FIG. 8 shows only one of the processors 801. Alternatively, the processor 801 can be a Central Processing Unit (CPU), Graphics Processing Unit (GPU), or Digital Signal processor (Digital Signal Processor). DSP). If device for simultaneous localization and mapping initialization 800 has a plurality of processors 801, the types of the plurality of processors 801 can be different, or can be the same. Alternatively, the plurality of processor 801 of the device for simultaneous localization and mapping initialization 800 can also be integrated as a multi-core processor.

The memory 802 stores computer instructions and data. The memory 802 may store computer instructions and data necessary to implement the method for simultaneous localization and mapping initialization provided in this application, for example, the memory 802 stores instructions for implementing the steps of the method for simultaneous localization and mapping initialization. The memory 802 may be any or a combination of any of the following storage media: Non-volatile Memory (e.g. Read Only Memory (ROM), Solid State Drive (SSD), Hard Disk Drive (HDD), optical disc), volatile memory.

The communication interface 803 may provide information input/output to at least one processor. It may also include any one or any combination of the following: a network interface (such as an Ethernet interface), a wireless network card, and other devices with network access functions.

Alternatively, the communication interface 803 can also be used for device for the device for simultaneous localization and mapping initialization 800 for data communication with other computing devices or terminals.

Alternatively, the bus 804 is represented by a thick line in FIG. 8. The bus 804 connects the processor 801 to the memory 802 and the communication interface 803. In this way, through the bus 804, the processor 801 can access the memory 802, and can also use the communication interface 803 to interact with other computing devices or terminals.

In this application, the device for simultaneous localization and mapping initialization 800 executes the computer instructions in the memory 802, causing the device for simultaneous localization and mapping initialization 800 to implement the method for simultaneous localization and mapping initialization provided in this application, or causing the device for simultaneous localization and mapping initialization 800 to deploy the apparatus for simultaneous localization and mapping initialization.

From the logical function division, as an example, as shown in FIG. 8, the memory 802 may include the image preprocessing module 701, the key frame screening module 702 and the simultaneous localization and mapping initialization module 703. The inclusion here refers only to the functions of image preprocessing module, the key frame screening module and the simultaneous localization and mapping initialization module when the instructions stored in the memory are executed, but not limited to the physical structure.

In addition, the device for simultaneous localization and mapping initialization can be realized by software, as shown in FIG. 8, but also as a hardware module, or as a circuit unit, through hardware.

The present application provides a computer-readable storage medium. The computer program product includes a computer instruction, and the computer instruction instruct the computing equipment to perform the method for simultaneous localization and mapping initialization provided in the present application.

The present application provides a computer program product comprising a computer instruction that is executed by a processor to implement the method of the first aspect.

The present application provides a chip comprising at least one processor and a communication interface that provides information input and/or output to the at least one processor. Further, the chip may also contain at least one memory for storing computer instructions. The at least one processor is used to invoke and run the computer instruction to perform the method for simultaneous localization and mapping initialization provided by the present application.

In the several embodiments provided in the present application, it should be understood that the disclosed apparatus and method may be implemented in other ways. For example, the above-described apparatus embodiments is only schematic, for example, the division of the units is only a logical function division, and there may be other ways of division in actual implementations, for example, multiple units or components may be combined or integrated into another system, or some features may be ignored or not executed. On the other hand, the shown or discussed mutual coupling or direct coupling or communication connection may be indirect coupling or communication connection through some interfaces, apparatuses or units, which may be in electrical, mechanical or other forms.

The units described as separate components may or may not be physically separated, and the components displayed as units may or may not be physical units, that is, they may be located in one place or distributed over multiple network units. Some or all of the units can be selected according to the actual needs to achieve the purpose of the solutions in the embodiments.

In addition, each functional unit in each embodiment of the present application may be integrated into one processing unit, or each unit may exist physically alone, or two or more units may be integrated into one unit. The above integrated units can be realized in the form of hardware or hardware plus software functional units.

What is claimed is:

1. A method for simultaneous localization and mapping initialization, comprising:
obtaining a predetermined number of continuous frame images and preprocessing the predetermined number of continuous frame images, the preprocessing comprising an operation of removing influence of rotation;
screening, with a pre-built adaptive-sized sliding window, initial key frames from the predetermined number of continuous frame images with the influence of rotation removed, the initial key frames comprising a plurality of key frames; and
performing, based on the plurality of key frames, simultaneous localization and mapping initialization.

2. The method of claim 1, wherein the performing, based on the plurality of key frames, simultaneous localization and mapping initialization comprises:
determining relative poses of a first key frame and a last key frame in the plurality of key frames;
obtaining, based on the relative poses of the first key frame and the last key frame, three-dimensional space points of respective key frames in the plurality of key frames;
determining relative poses of respective key frames in the plurality of key frames based on the relative poses of the first key frame and the last key frame and the three-dimensional space points of respective key frames in the plurality of key frames; and
establishing an initial map based on the three-dimensional space points of respective key frames in the plurality of key frames and the relative poses of respective key frames in the plurality of key frames.

3. The method of claim 2, wherein the determining relative poses of respective key frames in the plurality of key frames based on the relative poses of the first key frame and the last key frame and the three-dimensional space points of respective key frames in the plurality of key frames comprises:
determining positions of the three-dimensional space points of respective key frames in the plurality of key frames projected into the first key frame and the last key frame;
determining a first reprojection error based on the positions obtained by the projection; and
determining the relative poses of respective key frames in the plurality of key frames based on the first reprojection error and the three-dimensional space points of respective key frames in the plurality of key frames.

4. The method of claim 3, wherein the first reprojection error is a reprojection error after removing the influence of rotation.

5. The method of claim 2, before the establishing an initial map based on the three-dimensional space points of respective key frames in the plurality of key frames and the relative poses of respective key frames in the plurality of key frames, further comprising:
determining a second reprojection error based on the three-dimensional space points of respective key frames in the plurality of key frames;
performing a global optimization based on the second reprojection error to obtain the three-dimensional space points of respective key frames in the plurality of key frames and the relative poses of respective key frames in the plurality of key frames after the optimization; and
wherein the establishing an initial map based on the three-dimensional space points of respective key frames in the plurality of key frames and the relative poses of respective key frames in the plurality of key frames comprises:
establishing the initial map based on the three-dimensional space points of respective key frames in the plurality of key frames and the relative poses of respective key frames in the plurality of key frames after the optimization.

6. The method of claim 5, wherein the performing a global optimization based on the second reprojection error to obtain the three-dimensional space points of respective key frames in the plurality of key frames and the relative poses of respective key frames in the plurality of key frames after the optimization comprises:
deciding whether the second reprojection error reaches a predetermined error threshold; and
in response to a determination that the second reprojection error does not reach the predetermined error threshold, adjusting a size of the sliding window, determining the sliding window after adjustment as a new sliding window, reperforming the act of screening, with the new sliding window, initial key frames from the predetermined number of continuous frame images with the influence of rotation removed so that the second reprojection error reaches the predetermined error threshold, and obtaining the three-dimensional space points of respective key frames in the plurality of key frames and the relative poses of respective key frames in the plurality of key frames after the optimization.

7. The method of claim 1, wherein the screening, with a pre-built adaptive-sized sliding window, initial key frames from the predetermined number of continuous frame images with the influence of rotation removed comprises:
screening the initial key frames in the sliding window with a pixel distance difference with the influence of rotation removed.

8. The method of claim 2, wherein the determining relative poses of a first key frame and a last key frame in the plurality of key frames comprises:
extracting two-dimensional key points of the first key frame and the last key frame to obtain a two-dimensional key point of the first key frame and a two-dimensional key point of the last key frame; and
determining the relative poses of the first key frame and the last key frame with the two-dimensional key point of the first key frame and the two-dimensional key point of the last key frame.

9. The method of claim 8, wherein the determining the relative poses of the first key frame and the last key frame with the two-dimensional key point of the first key frame and the two-dimensional key point of the last key frame comprises:
determining an essential matrix corresponding to the first key frame and the last key frame with the two-dimensional key point of the first key frame and the two-dimensional key point of the last key frame;
obtaining, based on the essential matrix, a rotation matrix R and a translation matrix T; and
determining, based on the rotation matrix R and the translation matrix T, the relative poses of the first key frame and the last key frame.

10. The method of claim 2, wherein the obtaining, based on the relative poses of the first key frame and the last key frame, three-dimensional space points of respective key frames in the plurality of key frames comprises:
obtaining three-dimensional space points of the first key frame and the last key frame based on the relative poses of the first key frame and the last key frame; and
determining three-dimensional space points of respective key frames remaining in the plurality of key frames except the first key frame and the last key frame based on the three-dimensional space points of the first key frame and the last key frame and a feature matching relationship between frames in the plurality of key frames.

11. The method of claim 10, wherein the obtaining three-dimensional space points of the first key frame and the last key frame based on the relative poses of the first key frame and the last key frame comprises:
performing, based on the relative poses of the first key frame and the last key frame, a triangulation calculation to obtain the three-dimensional space points of the first key frame and the last key frame.

12-17. (canceled)

18. A device for simultaneous localization and mapping initialization, comprising:
a processor;
a memory; and
a computer program;
wherein the computer program is stored in the memory and configured to be executed by the processor, and the computer program comprises an instruction for executing a method comprising:
obtaining a predetermined number of continuous frame images and preprocessing the predetermined number of continuous frame images, the preprocessing comprising an operation of removing influence of rotation;
screening, with a pre-built adaptive-sized sliding window, initial key frames from the predetermine number of continuous frame images with the influence of rotation removed, the initial key frames comprising a plurality of key frames, and
performing, based on the plurality of key frames, simultaneous localization and mapping initialization.

19. A non-transitory computer-readable storage medium, wherein the computer-readable storage medium stores a computer program that causes a server to execute a method comprising:
obtaining a predetermined number of continuous frame images and preprocessing the predetermined number of continuous frame images, the preprocessing comprising an operation of removing influence of rotation;
screening, with a pre-built adaptive-sized sliding window, initial key frames from the predetermine number of continuous frame images with the influence of rotation removed, the initial key frames comprising a plurality of key frames, and
performing, based on the plurality of key frames, simultaneous localization and mapping initialization.

20-21. (canceled)

22. The device of claim 18, wherein the performing, based on the plurality of key frames, simultaneous localization and mapping initialization comprises:
determining relative poses of a first key frame and a last key frame in the plurality of key frames;
obtaining, based on the relative poses of the first key frame and the last key frame, three-dimensional space points of respective key frames in the plurality of key frames;
determining relative poses of respective key frames in the plurality of key frames based on the relative poses of the first key frame and the last key frame and the three-dimensional space points of respective key frames in the plurality of key frames; and
establishing an initial map based on the three-dimensional space points of respective key frames in the plurality of key frames and the relative poses of respective key frames in the plurality of key frames.

23. The device of claim 22, wherein the determining relative poses of respective key frames in the plurality of key frames based on the relative poses of the first key frame and the last key frame and the three-dimensional space points of respective key frames in the plurality of key frames comprises:
determining positions of the three-dimensional space points of respective key frames in the plurality of key frames projected into the first key frame and the last key frame;
determining a first reprojection error based on the positions obtained by the projection; and
determining the relative poses of respective key frames in the plurality of key frames based on the first reprojection error and the three-dimensional space points of respective key frames in the plurality of key frames.

24. The device of claim 23, wherein the first reprojection error is a reprojection error after removing the influence of rotation.

25. The device of claim 22, before the establishing an initial map based on the three-dimensional space points of respective key frames in the plurality of key frames and the relative poses of respective key frames in the plurality of key frames, further comprising:
determining a second reprojection error based on the three-dimensional space points of respective key frames in the plurality of key frames;
performing a global optimization based on the second reprojection error to obtain the three-dimensional space points of respective key frames in the plurality of key frames and the relative poses of respective key frames in the plurality of key frames after the optimization; and
wherein the establishing an initial map based on the three-dimensional space points of respective key frames in the plurality of key frames and the relative poses of respective key frames in the plurality of key frames comprises:
establishing the initial map based on the three-dimensional space points of respective key frames in the plurality of key frames and the relative poses of respective key frames in the plurality of key frames after the optimization.

26. The device of claim 25, wherein the performing a global optimization based on the second reprojection error to obtain the three-dimensional space points of respective key frames in the plurality of key frames and the relative poses of respective key frames in the plurality of key frames after the optimization comprises:
deciding whether the second reprojection error reaches a predetermined error threshold; and
in response to a determination that the second reprojection error does not reach the predetermined error threshold, adjusting a size of the sliding window, determining the sliding window after adjustment as a new sliding window, reperforming the act of screening, with the new sliding window, initial key frames from the predetermined number of continuous frame images with the influence of rotation removed so that the second reprojection error reaches the predetermined error threshold, and obtaining the three-dimensional space points of respective key frames in the plurality of key frames and the relative poses of respective key frames in the plurality of key frames after the optimization.

27. The device of claim 18, wherein the screening, with a pre-built adaptive-sized sliding window, initial key frames from the predetermined number of continuous frame images with the influence of rotation removed comprises:
screening the initial key frames in the sliding window with a pixel distance difference with the influence of rotation removed.

28. The device of claim 22, wherein the determining relative poses of a first key frame and a last key frame in the plurality of key frames comprises:
extracting two-dimensional key points of the first key frame and the last key frame to obtain a two-dimensional key point of the first key frame and a two-dimensional key point of the last key frame; and
determining the relative poses of the first key frame and the last key frame with the two-dimensional key point of the first key frame and the two-dimensional key point of the last key frame.
